(19) United States
(12) Patent Application Publication
(10) Pub. No.: US 2026/0331805 A1
(43) Pub. Date: Oct. 22, 2026

(54) Standardized High Voltage Cable Assembly System for FFC/FPC

(71) Applicant: TE Connectivity Solutions GmbH, Schaffhausen (CH)

(72) Inventor: Christopher Ryan Raybold, Middletown, PA (US)

(73) Assignee: TE Connectivity Solutions GmbH, Schaffhausen (CH)

(21) Appl. No.: 19/180,795

(22) Filed: Apr. 16, 2025

(51) Int. Cl. H01R 12/77

(52) U.S. Cl. CPC H01R 12/771; H01R 12/778

(57) ABSTRACT

A cable assembly comprises a flexible flat cable (FFC), an inner housing and an outer housing. The outer housing defines an internal cavity, and a first cable opening in communication with the internal cavity and adapted to receive the FFC in an insertion direction. The inner housing is selectively fixable to the outer housing at least partially within the internal cavity, and includes a plurality of terminal openings, and a second cable opening aligned with the first cable opening of the outer housing and receiving a free end of the FFC. The plurality of terminal openings have a plurality of conductive terminals arranged therein, with each terminal having a first end adapted to engage with a corresponding mating terminal of a mating connector and a second end conductively connected to one of a plurality of exposed conductors of the FFC.

### FIELD OF THE INVENTION

The present disclosure relates to electrical connectors, and more particularly, to a connector assembly suitable for electrically connecting flat flexible cables in a high voltage system.

### BACKGROUND OF THE INVENTION

Flexible flat cables (FFCs) or flexible printed cables (FPCs) are electrical components consisting of at least one conductor (e.g., a metallic foil conductor) embedded within a thin, flexible strip of insulation. Flat flexible cables are gaining popularity across many industries due to advantages provided over their traditional “round wire” counter parts. Specifically, in addition to having a lower profile and lighter weight, FFCs enable the implementation of large circuit pathways with significantly greater ease, and utilize substantially less space or volume, compared to a round wire-based architectures. As a result, FFCs are being implemented into many complex and/or high-volume applications, including wiring harnesses such as those used in automotive/electric vehicle manufacturing.

There is also trend within electric vehicles to minimize copper weight by increasing system voltages to reduce current and the required wire size to carry that current. As a result, 48V electrical systems are gaining popularity. Given the complexity of these applications, there is a corresponding need to develop standardized connector systems for 48V electrical systems that would reduce the number of connector types used within vehicles. Using FFCs in conjunction with 48 volt systems offers many advantages, including reductions in the sizes of connector housings, the weight of the system, and its overall complexity. Implementing FFCs into a high voltage system is not without difficulties, however. Required considerations include the increased challenges associated with sealing FFCs, providing adequate strain relief, as well as achieving the conductor clearances required for high voltage applications.

Accordingly, there is a need for a connector system adapted for use with FFCs in a high voltage environment, which facilitates automated manufacturing and component standardization.

### SUMMARY OF THE INVENTION

In one embodiment of the present disclosure, a cable assembly comprises a flexible flat cable (FFC), an inner housing and an outer housing. The outer housing defines an internal cavity, and a first cable opening in communication with the internal cavity and adapted to receive the FFC in an insertion direction. The inner housing is selectively fixable to the outer housing at least partially within the internal cavity, and includes a plurality of terminal openings and a second cable opening aligned with the first cable opening of the outer housing and receiving a free end of the FFC. The plurality of terminal openings have a plurality of conductive terminals arranged therein, with each terminal having a first end adapted to engage with a corresponding mating terminal of a mating connector and a second end conductively connected to one of a plurality of exposed conductors of the FFC.

### BRIEF DESCRIPTION OF DRAWINGS

The invention will now be described by way of example with reference to the accompanying Figures, of which:

FIG. 1 is a top (or bottom) perspective view of an exemplary FFC useful for describing a connector system according to embodiments of the present disclosure;

FIG. 2 is a cross-sectional view of the FFC of FIG. 1 taken along section A-A;

FIG. 3 is a top perspective view of an FFC and stiffening element according to an embodiment of the present disclosure;

FIG. 4 is a bottom perspective view of the FFC and stiffening element of FIG. 3;

FIG. 5 is a side perspective view of a terminal used in a connector, plug and/or cable assembly according to an embodiment of the present disclosure;

FIG. 6 is a side view of the terminal of FIG. 5;

FIG. 7 is a front perspective view of a cable subassembly including an FFC, a stiffening element and a plurality of the terminals, according to an embodiment of the present disclosure;

FIG. 8 is a front perspective view of an inner housing of the connector system according to an embodiment of the present disclosure;

FIG. 9 is a cross-sectional view of the inner housing of FIG. 8 taken along section B-B;

FIG. 10 is a rear perspective view of an outer housing of the connector system according to an embodiment of the present disclosure;

FIG. 11 is a front perspective view of the outer housing of FIG. 10;

FIG. 12 is an exploded side perspective view of the connector system according to an embodiment of the present disclosure;

FIG. 13 is a cross-sectional view of the system of FIG. 12 taken along section C-C;

FIG. 14 is a front perspective view of the connector assembly of FIGS. 12 and 13 in an assembled state; and

FIG. 15 is a rear perspective view of the connector system of FIG. 14.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to one embodiment of the present disclosure, a cable assembly comprises an FFC, an inner housing and an outer housing. The outer housing defines an internal cavity, as well as a first cable opening in communication with the internal cavity and adapted to receive the FFC in an insertion direction. The inner housing is selectively fixable to the outer housing at least partially within the internal cavity, and includes a plurality of terminal openings, and a second cable opening aligned with the first cable opening of the outer housing and receiving a free end of the FFC. The plurality of terminal openings have a plurality of conductive terminals arranged therein, with each terminal having a first end adapted to engage with a corresponding mating terminal of a mating connector and a second end conductively connected to one of a plurality of exposed conductors of the FFC. Seals are formed between the FFC and the first cable opening, as well as between the outer housing and the mating connector or header (not shown).

According to another embodiment of the present disclosure, a connector for an FFC includes an outer housing having a first cable opening formed therethrough and adapted to receive the FFC in an insertion direction. The connector further includes an inner housing having a plurality of terminal openings adapted to receive a plurality of conductive terminals, and a second cable opening in communication with the plurality of terminal openings. The second cable opening is adapted to receive a free end of the FFC inserted through the first cable opening of the outer housing. The inner housing is selectively fixable to the outer housing such that the first cable opening and the second cable opening are aligned in the insertion direction.

In another embodiment of the present disclosure, a method of manufacturing an FFC system includes the steps of: 1) arranging a plurality of conductive terminals within an inner connector housing, with each terminal defining a weld/solder area adapted to be electrically connected to a conductor of an FFC; 2) inserting a free end of the FFC through a cable opening in an outer connector housing in a first direction; 3) inserting the free end of the FFC into the inner connector housing such that a plurality of conductors of the FFC align with respective ones of the plurality of terminals; 4) welding/soldering the plurality of conductors to the plurality of terminals; 5) after joining the conductors to the terminals, inserting the inner connector housing into the outer connector housing; and 6) mechanically fixing the inner connector housing to the outer connector housing.

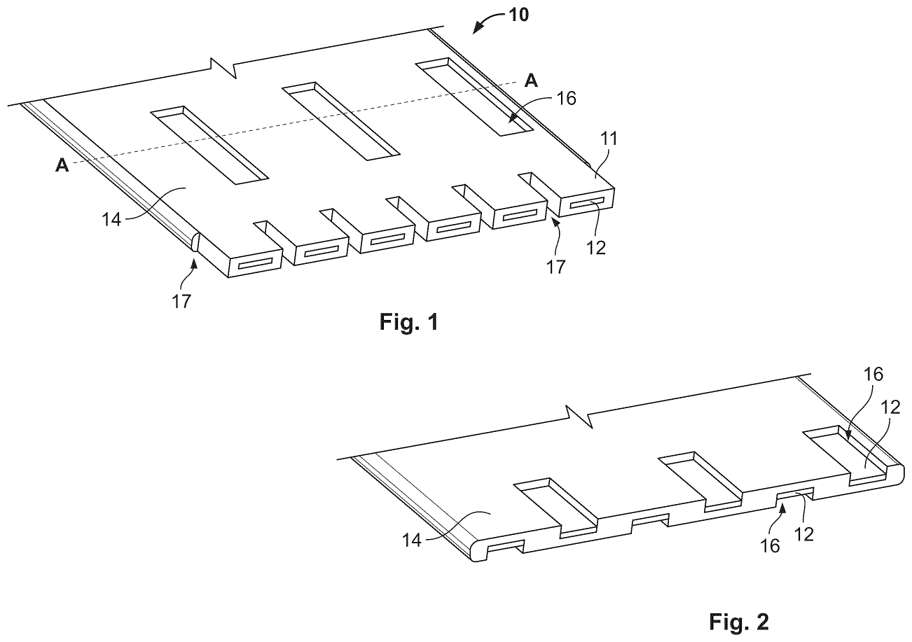

Referring now to FIGS. 1 and 2, an exemplary FFC 10 useful for describing embodiments of the present disclosure is shown. The FFC 10 includes one or more conductors 12 embedded within an insulating material 14. The conductors 12 may comprise metallic sheet or foil, such as copper foil, by way of example only, patterned in any desirable configuration. In the exemplary embodiment, the conductors 12 comprise linear or longitudinally extending, conductive traces or pathways. The insulating material 14, such as a polymer insulating material, may be applied to either side of the conductors 12 via an adhesive (laminated construction) or extruded, resulting in an embedded conductor arrangement. The insulation material 14 may be selectively removed, or not initially applied, in desired areas for exposing the conductors 12, such as in windows 16 defined on a top and/or bottom side of the exemplary illustrated FFC 10. In the exemplary embodiment, the windows 16 may be formed on the top and bottom sides of the FFC 10, such that conductors 12 are exposed on each side of the FFC 10 in an alternating fashion across its width, as shown in the cross-sectional view of FIG. 2. As will be described in greater detail herein, the exposed portion of each of the conductors 12 is adapted to be connected (e.g., soldered or welded) to a respective conductive terminal. The formation of the windowing on each side of the FFC 10 permits terminals to be electrically connected to both sides (i.e., top and bottom) of the FFC 10, which may improve connector density and/or reduce the size of a connector housing. Still referring to FIGS. 1 and 2, slots or serrations 17 may be formed through the insulation material 14, particularly in areas between the conductors 12 on and/or into a free end 11 of the FFC 10. The slots 17 may correspond to protruding features within a plug or housing for positioning the FFC 10 therein during manufacturing, and/or for maintaining the creep and clear requirements of the cable.

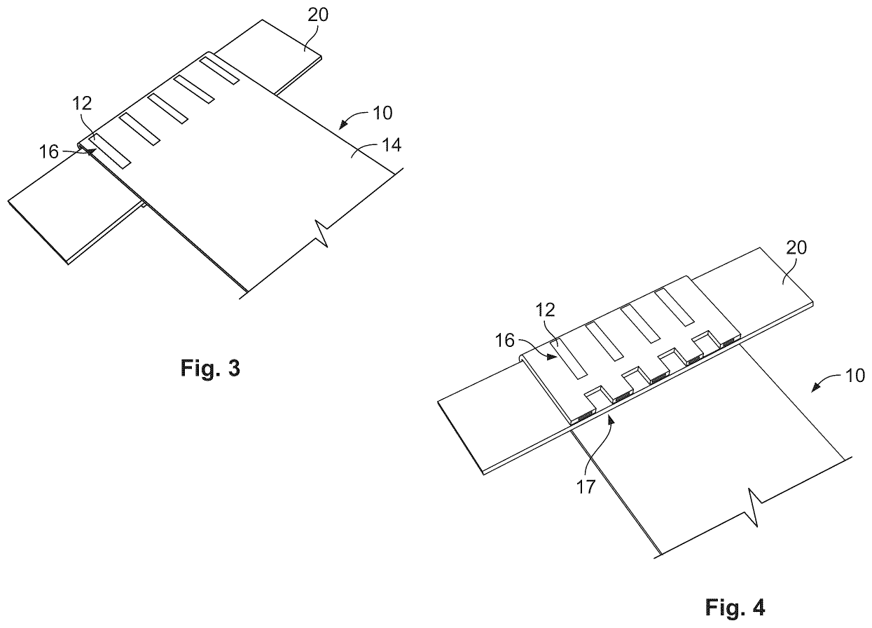

With reference now to FIGS. 3 and 4, in another embodiment, the FFC 10 may be fitted with a stiffening element or stiffener 20 to form a cable subassembly. Specifically, the stiffening element 20 may comprise a generally planar rectangular element, which may be formed from an insulating polymer material. A free end of the exemplary illustrated FFC 10 is wrapped around the stiffening element 20 (e.g., folded thereover at approximately 180 degrees), and may be bonded therewith via, for example, an adhesive hotmelt. As shown, the illustrative FFC 10 has nine total conductors 12 exposed through windows 16 on each of the illustrated top and bottom sides after folding, with the free end of the FFC defining the serrations or saw-tooth configuration of the slots 17. As distinct from the FFC 10 of FIGS. 1 and 2, in this embodiment, the windows 16 are formed only on one side of the FFC 10 prior to folding about the stiffening element 20, simplifying the manufacturing process of the FFC. The use of the stiffening element 20 bonded to the FFC 10 has several advantages. For example, it enables accurate positioning of the FFC within a larger plug or connector, facilitates precise alignment with associated terminals, as well as improves the mechanical stability and strain relief of the FFC.

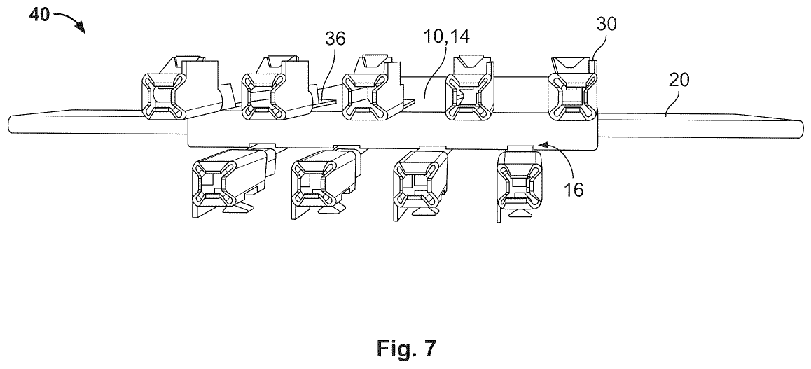

An exemplary subassembly 40 including a 9-conductor FFC 10, a stiffening element 20, and a plurality of terminals 30 is shown in FIG. 7. As illustrated, exposed conductors 12 on each side of the stiffening element 20 after folding (5 and 4 conductors, respectively) may be soldered or welded with the terminals 30 prior to, or after, insertion into an exemplary connector housing. The staggering of the top and bottom terminals 30 relative to one another in the vertical direction is dictated by the lateral spacing of the 9 conductors 12 across the FFC 10. The terminal staggering in this folded FFC arrangement enables greater terminal/conductor density and improved packaging efficiency. By way of example, the 9 conductors of the single FFC 10 may originate from the joinder of multiple discrete downstream FFCs of a cable assembly. More specifically, a 5 conductor FFC and a 4 conductor FFC may be joined to form the compound 9 conductor FFC 10.

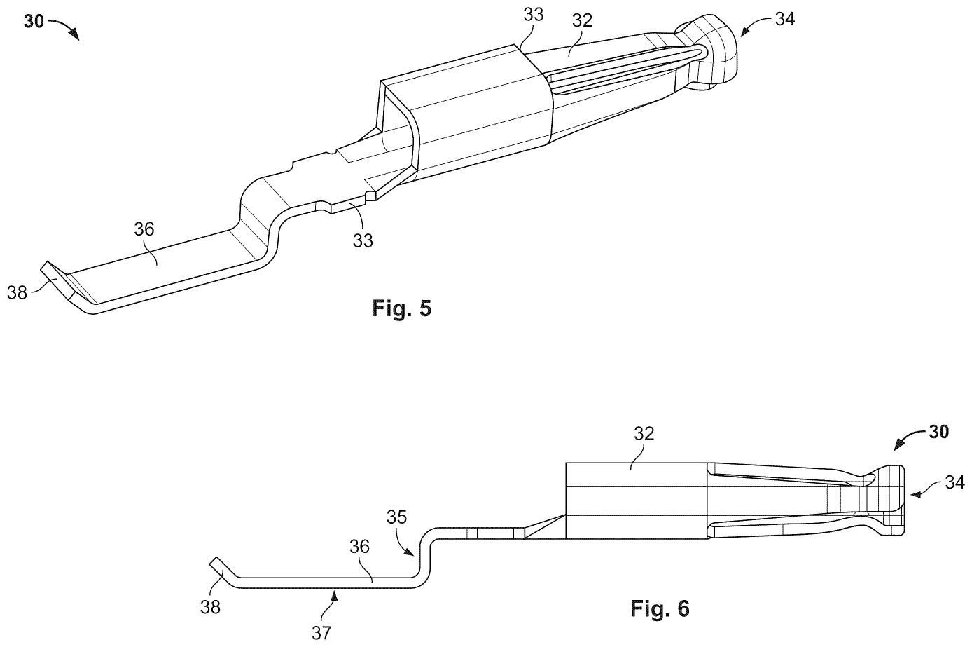

Detailed views of the exemplary conductive terminal 30 according to embodiments of the present disclosure are illustrated in FIGS. 5 and 6. The exemplary terminal 30 has a body 32 defining a female mating end or opening 34 adapted to receive, for example, a conductive male mating terminal (e.g., a pin terminal) therein.

A weld end 36 of the terminal 30 defines a weld area or surface 37 on an underside thereof adapted to be electrically connected to the exposed conductor 12 of the FFC 10 via welding or soldering. As shown, a free end 38 of the weld end 36 is inclined in a direction away from the weld surface 37, or curves radially upward in the orientation shown. The obliquely extending free end 38 enables the FFC 10 may be more easily inserted into a connector in which the terminals 30 are arranged without risk of damage to the conductors 12, as will be illustrated below.

In the exemplary terminal 30, the weld end 36 is offset (i.e., in a direction normal to a mating direction of the terminal) from a remainder of the terminal body 32 via a stepdown section 35, including two generally ninety-degree bends formed into the weld end 36 to define a generally Z-shaped or stepped profile. As can be visualized from the figures, the terminal 30 may be formed by a combination of sheet metal forming operations, such as stamping and bending. Additional stamping may be utilized to flatten the weld end 36 to a sufficiently wide and uniformly flat surface optimized for soldering to the FFC. The weld end 36, and in particular the weld area 37, may be tinned with solder, with flux applied thereover prior to its installation into a connector or plug. For the embodiment of FIGS. 3 and 4, the stepdown 35 would be omitted and the weld area 37 would be aligned with the carrier cut off area 33.

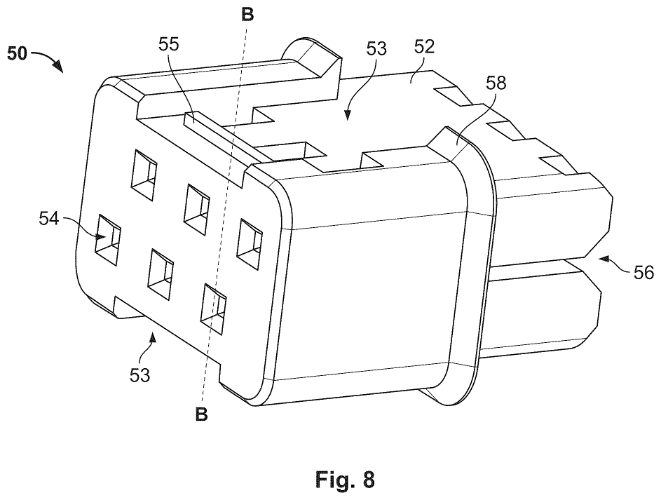

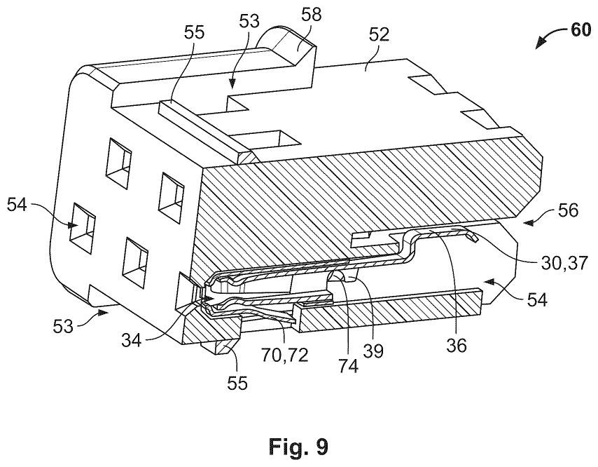

The terminals 30 are adapted to be fitted into a connector or plug assembly. Specifically, referring to FIGS. 8 and 9, an inner housing 50 of a connector according to an embodiment of the present disclosure shown. The inner housing 50 includes a body 52 (e.g., an insulative polymer body) defining a plurality of terminal openings 54. The terminal openings 54 are adapted to receive above-described terminals 30 (e.g., from the rear as shown in FIG. 9). The terminals 30 may be preloaded into the inner housing 50 to define an inner housing assembly 60. It should be understood that, beneficially, this inner housing assembly 60 may be manufactured/assembled in advance of final integration into a given cable system, as will be set forth in greater detail herein.

The body 52 of the inner housing 50 further defines a cable slot or opening 56. The cable slot 56 extends into a rear of the body and in communication with each of the terminal openings 54. The cable slot 56 is adapted to receive the FFC 10, or the subassembly of the FFC and the stiffening element 20 as shown in FIGS. 3 and 4, in the indicated direction (i.e., from the open rear side thereof toward a front of the inner housing 50).

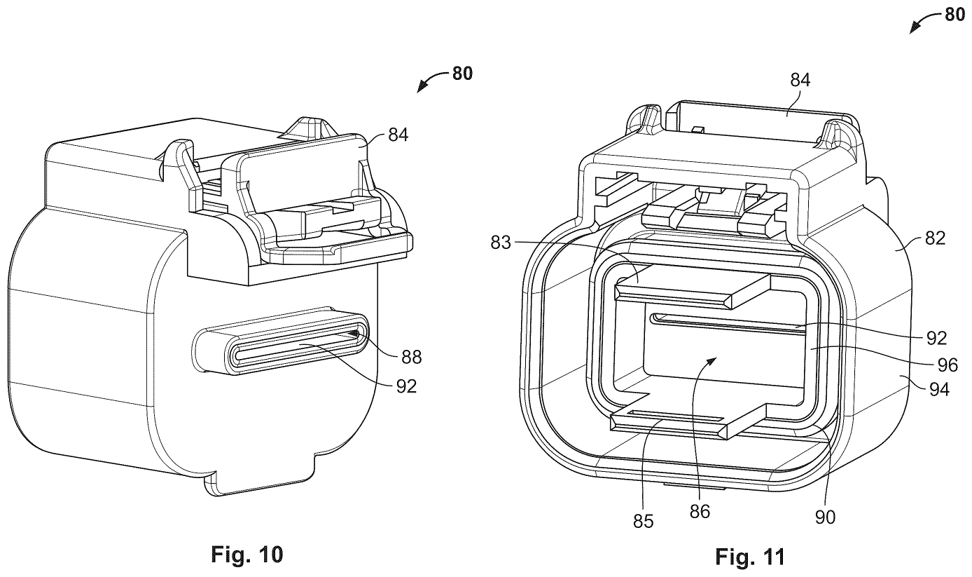

The body 52 of the inner housing 50 further defines an inner seal retainer 58 (e.g., a retaining protrusion or lip) generally surrounding the body. The inner seal retainer 58 is adapted to engage with an inner seal of an outer housing assembly 80, as shown in FIGS. 10-14. The inner housing 50 also defines longitudinally extending slots 53 on each of a top and bottom side thereof. The slots 53 are adapted to engage with or receive corresponding features of the outer housing assembly 80. Specifically, a catch 55 may be formed in each of the slots 53 which is adapted to engage with a latch of the outer housing assembly 80, as shown in FIGS. 10-14, for selectively securing or fixing the inner housing 50 to the outer housing assembly 80.

With specific reference to the cross-sectional view of FIG. 9, in some embodiments, each terminal 30 may be directly fixed to the body 52 within a respective one of the terminal openings 54. This may be achieved via friction fit and/or an integrated locking/latching features of the terminals 30 and/or the inner housing 50. In the illustrated embodiment, however, a locking lance or insert 70 (e.g., a stainless steel locking insert) may be installed into each terminal opening 54 prior to the loading the terminal 30 into the inner housing 50. The lance 70 includes a latch 72 engaging with a slot or opening of the body 52 for securing the lance within the terminal opening 54. The lance 70 further defines a locking protrusion 74. The locking protrusion 74 engages with a complementary locking feature 39 of the terminal 30 for securing the terminal 30 to the lance upon insertion, thus retaining and positioning the terminal within the terminal opening 54.

Still referring to FIG. 9, with the terminal(s) 30 installed in the terminal opening(s) 54, the weld end 36 of the terminal extends into, or is in communication with, the cable opening 56 such that the weld surface 37 of each terminal 30 is positioned in the cable opening. In this way, the weld surface 37 of each terminal 30 is exposed within the cable opening 56 such that it opposes and contacts a respective exposed conductor 12 of the FFC 10 after insertion of the FFC into the inner housing 50. After insertion of the FFC 10 into the inner housing 50, each of the terminals 30 may be soldered or welded to a respective one of the conductors.

It should be understood that, while only a single terminal 30 is shown in FIG. 9, additional terminals would be arranged in each of the illustrated terminal openings 54, with the bottom row of terminals oriented as shown, and the top row of terminals oriented inversely, such that their weld surfaces face downwardly or opposite to the weld surface 37 of the illustrated bottom or lower terminal 30. In this way, the terminals 30 may be welded to each of a top and bottom side of an unfolded, single extruded FFC 10 inserted into the cable opening 56, or to the same (albeit oppositely facing) side of a folded FFC 10 as shown in FIGS. 3, 4 and 11.

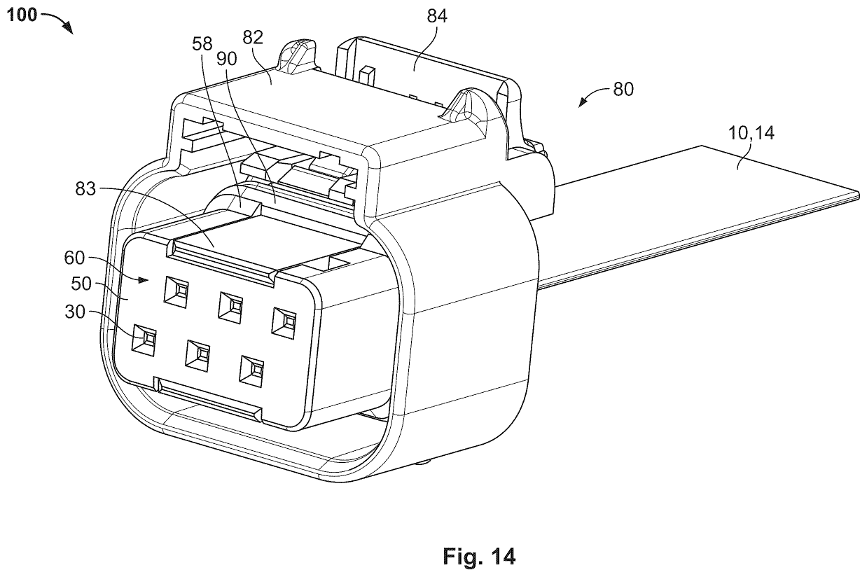

FIGS. 10 and 11 show the outer housing assembly 80 of the connector or connector assembly according to an embodiment of the present disclosure in greater detail. Generally, the outer housing assembly 80 includes an outer housing or body 82 (e.g., a molded polymer body). The body 82 has an outer perimeter wall 94 and an inner perimeter wall 96. The inner perimeter wall 96 defines an inner housing receiving space 86 into which the inner housing 50 is adapted to be fixedly received. Specifically the inner perimeter wall 96 of the body 82 defines latches or latch arms 83 on top and bottom sides thereof. The latch arms 83 are adapted to engage with the inner housing 50, as shown in FIG. 14. More specifically, in one embodiment, each latch arm 83 defines a receiving slot 85 adapted to engage with the catches 55 of the inner housing 50.

The body 82 of the outer housing assembly 80 further defines a cable opening 88 into which the FFC 10 is adapted to be received and pass therethrough. The cable opening 88 communicates with the inner housing receiving space 86. A cable seal or outer seal 92 (e.g., a rubber or polymer sealing ring) is fitted within the cable opening 88 and is adapted to form a seal with the FFC 10 once inserted therethrough.

As shown in FIG. 11, an inner seal 90 is also provided about the inner peripheral wall 96 and extends into an annular or circumferential opening, or mating connector space, defined between the inner peripheral wall and the outer peripheral wall 94. The inner seal 90 is adapted to abut the inner housing 50, and specifically the inner seal retainer 58. As can be visualized from FIG. 11, a radially outward facing ribbed side of the inner seal 90 is adapted to sealingly engage with a radially inward facing sealing surface of a mating connector (not shown) received between the inner wall 96 and the outer peripheral wall 94. As would be further understood by one of ordinary skill in the art, the mating connector may be fixed to the outer housing assembly 80 via the illustrated latching connection and associated connector position assurance (CPA) device 84.

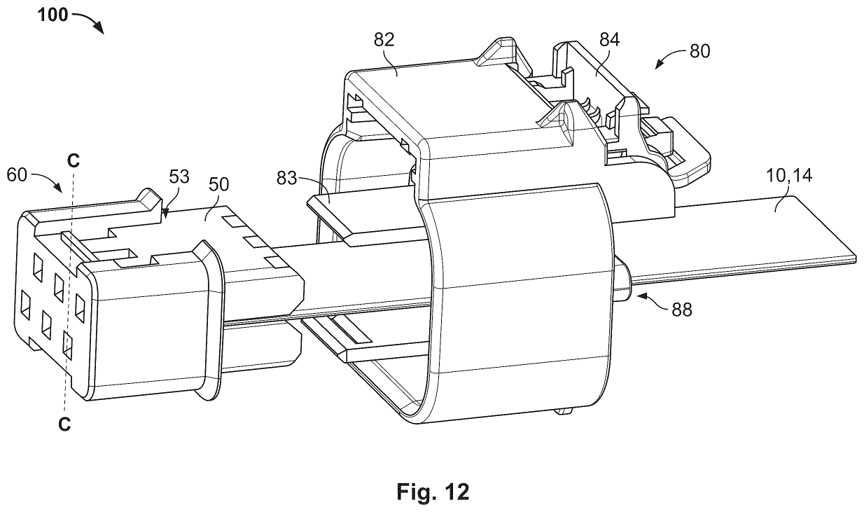

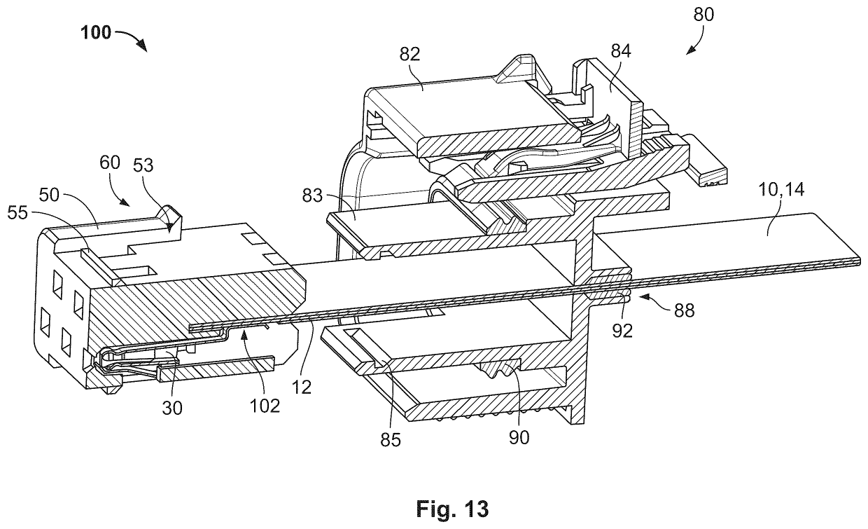

A connector or connector assembly/system according to embodiments of the present disclosure is shown in FIGS. 12-15. With reference to the unassembled views of FIGS. 12 and 13, the connector system or connector assembly 100 according to an embodiment of the present disclosure includes the preassembled inner housing assembly 60, the preassembled outer housing assembly 80, and the FFC 10. In a final assembly process of the connector assembly 100, the FFC 10 (with or without the stiffening element 20) is inserted through the cable opening 88 of the body 82 of the outer housing assembly 80, and into the cable slot or opening 56 of the inner housing 50. Once fully inserted, the exposed conductors 12 of the FFC 10 are aligned with, and abuttingly oppose and contact each of the weld surfaces 37 of the terminals 30. Using, for example, soldering or welding at the illustrated joints 102 (see FIG. 13), the terminals 30 are soldered onto respective ones of the conductors 12 of the FFC 10 within the inner housing 50.

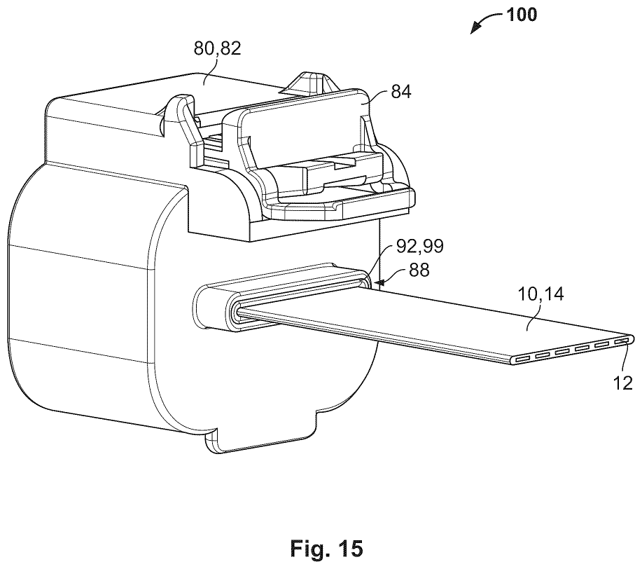

Referring now to the assembled views of the system 100 of FIGS. 14 and 15, once the terminals 30 have been fixed (e.g., welded) to the FFC 10, the inner housing assembly 60 is inserted into the body 82 of the outer housing assembly 80 in a direction generally opposite to an insertion direction of the FFC 10 into the outer housing assembly 80, and fixedly connected thereto. More specifically, the locking latches 83 of the body 82 extending into the slots 53 of the inner housing 50 until the recesses 85 receive the catches 55, thereby snap-fitting the inner housing assembly 60 within the outer housing assembly 80, as shown in FIG. 14. In this position, the inner seal 90 of the outer housing assembly 80 abuts the inner seal retainer 58 of the inner housing 50 about its perimeter in a direction of insertion of the inner housing into the outer housing. The illustrated sealing ribs of the inner seal 90 extend radially outward and into the receiving space of the mating connector, as described above, for forming a seal therewith upon mating or plugging of the system 100 to a mating connector.

With the inner housing assembly 60 and outer housing assembly 80 mated, the outer seal 92 is then heated to bond to the insulation material or jacket 14 of the FFC 10 at a joint 99, as shown in FIG. 15. This forms a water-tight seal between the FFC 10 and the interior of the connector assembly 100. Further, bonding the outer seal 92 with the FFC 10 provides mechanical strain relief to the assembly, preventing pull-out of the FFC 10 and/or disconnection with the terminals 30.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A connector for a flexible flat cable (FFC), comprising:
an outer housing having a first cable opening formed therethrough and adapted to receive the FFC in an insertion direction; and
an inner housing, including:
a plurality of terminal openings adapted to receive a plurality of conductive terminals; and
a second cable opening in communication with the plurality of terminal openings and adapted to receive a free end of the FFC inserted through the first cable opening of the outer housing, the inner housing is selectively fixable to the outer housing such that the first cable opening and the second cable opening are aligned in the insertion direction.

2. The connector of claim 1, wherein the inner housing is selectively fixed to the outer housing via movement of the inner housing relative to the outer housing in a direction opposite to the insertion direction.

3. The connector of claim 1, further comprising a cable seal arranged about the first cable opening and adapted to form a seal with the FFC inserted through the first cable opening.

4. The connector claim 1, wherein the plurality of terminal openings open toward a front end of the inner housing, and are adapted to mate with corresponding mating terminals of a mating connector.

5. The connector of claim 4, wherein the plurality of terminal openings are adapted to receive the plurality of terminals therein from a rear end of the inner housing opposite the front end.

6. The connector of claim 4, further comprising an inner seal arranged within the outer housing and extending into a mating space adapted to receive a mating end of the mating connector.

7. The connector of claim 1, wherein the plurality of terminal openings are arranged in first and second rows, with the first row and the second row arranged on opposites side of the second cable opening.

8. A cable assembly, comprising:
a flexible flat cable (FFC) including a plurality of conductors embedded within an insulation material, a portion of each of the conductors exposed through a respective opening defined through the insulation material;
an outer housing defining an internal cavity and a first cable opening adapted to receive the FFC in an insertion direction and in communication with the internal cavity; and
an inner housing selectively fixable to the outer housing at least partially within the internal cavity, including:
a plurality of terminal openings having a plurality of conductive terminals arranged therein, each terminal including a first end adapted to engage with a corresponding mating terminal of a mating connector and a second end conductively connected to one of the exposed portions of the conductors of the FFC; and
a second cable opening aligned with the first cable opening and receiving a free end of the FFC arranged through the first cable opening.

9. The assembly of claim 8, wherein the inner housing is selectively fixed to the outer housing via relative movement of the inner housing relative to the outer housing in a direction opposite to the insertion direction.

10. The assembly of claim 8, further comprising a cable seal arranged about the first cable opening and forming a seal with the insulation material of the FFC.

11. The assembly of claim 8, further comprising an inner seal arranged within the internal cavity of the outer housing and having a sealing surface extending into a mating connector space adapted to receive a mating end of the mating connector.

12. The assembly of claim 8, wherein the terminal openings formed through the inner housing are arranged in a first row and a second row, the first row and the second row are oriented such that the second ends of the terminals are arranged on each of first and second sides of the FFC received within the second cable opening.

13. The assembly of claim 12, wherein the FFC includes openings on oppositely facing top and bottom sides thereof engaging with the second ends of the terminals in the first row and the second row, respectively.

14. The assembly of claim 12, further comprising a stiffening element, the free end of the FFC wrapped about the stiffening element 180 degrees.

15. The assembly of claim 14, wherein, with the stiffening element and the free end of the FFC inserted into the second cable opening, openings formed through one side of the insulation material of the FFC expose conductors in oppositely facing directions for mating with the second ends of the terminals in the first row and the second row, respectively.

16. A method of manufacturing a flexible flat cable (FFC) system, including steps of:
arranging a plurality of conductive terminals within an inner connector housing, each terminal defining a weld area adapted to be electrically connected to a conductor of an FFC;
inserting a free end of the FFC through a cable opening in an outer connector housing in a first direction;
after inserting the free end of the FFC through the outer connector housing, inserting the free end of the FFC into the inner connector housing such that a plurality of conductors of the FFC align with respective ones of the plurality of terminals;
welding the plurality of conductors to the plurality of terminals;
after welding the conductors to the terminals, inserting the inner connector housing into the outer connector housing; and
mechanically fixing the inner connector housing to the outer connector housing.

17. The method of claim 16, wherein the inner connector housing is inserted into the outer connector housing via relative movement between the inner connector housing and the outer connector housing in a second direction, opposite the first direction.

18. The method of claim 17, wherein as the inner connector housing is inserted into the outer connector housing, the FFC is biased in the second direction through the cable opening in the outer connector housing.

19. The method of claim 16, further comprising the step of, after the inner connector housing and the outer connector housing are fixed together, forming a seal between the cable opening and the FFC.

20. The method of claim 19, wherein the step of forming a seal between the cable opening of the outer connector housing and the FFC includes the steps of:
arranging a cable seal about the cable opening; and
bonding the cable seal to an insulation material of the FFC.
